(19) United States
(12) Patent Application Publication
(10) Pub. No.: US 2021/0089947 A1
(43) Pub. Date: Mar. 25, 2021

(54) Aquaculture Decision Optimization System Using A Learning Engine

(71) Applicants: Alex N. Beavers, JR., Bradenton, FL (US); Michael P. Crosby, Sarasota, FL (US)

(72) Inventors: Alex N. Beavers, JR., Bradenton, FL (US); Michael P. Crosby, Sarasota, FL (US)

(73) Assignee: Mote Marine Laboratory, Sarasota, FL (US)

(21) Appl. No.: 17/079,484

(22) Filed: Oct. 25, 2020

(51) Int. Cl. G06N 5/04; A01K 61/10; A01K 61/80; G06N 20/00; G06N 5/02

(52) U.S. Cl. CPC G06N 5/04; A01K 61/10; G06N 5/025; G06N 20/00; A01K 61/80

(57) ABSTRACT

The present invention relates to a machine learning based software system that helps aquaculture facility operators optimize the productivity of their aquatic farming operations. In particular, the present invention provides information useable by people and by computer-controlled machines about how to adjust feed recipes, feeding rates, controllable operational conditions such as air and water conditions, and other controllable environmental conditions so that the growth rate and size of farmed aquatic animals and plants can be maximized while the cost and ecological impact of the aquatic animals and plants being farmed are minimized

### CROSS-REFERENCE TO RELATED APPLICATIONS

This application is a nonprovisional application for a utility patent which claims priority from and the benefit of U.S. Provisional Application Ser. No. 62/926,081, entitled “Aquaculture Decision Optimization System Using A Learning Engine,” filed Oct. 25, 2019. Each of the foregoing applications is hereby incorporated by reference.

### STATEMENT REGARDING FEDERALLY SPONSORED RESEARCH OR DEVELOPMENT

(Not Applicable)

### REFERENCE TO SEQUENCE LISTING, A TABLE, OR A COMPUTER PROGRAM LISTING COMPACT DISC APPENDIX

(Not Applicable)

### BACKGROUND OF THE INVENTION

### Field of the Invention

The present invention relates to aquaculture which is the cultivation and farming of aquatic animals and plants in marine or freshwater environments in natural or constructed facilities on land, in coastal regions, or in open sea deep water areas.

### Description of the Related Art

The continued growth and productivity of the aquaculture industry demands that more automation and data-driven equipment be used in all forms and facilities of the farming of aquatic animal and plant species. The capacity and capability of conventional manual and computer techniques for collection, analysis, and management of data available in current and future aquaculture is being exceeded by the size and increasing growth rate of the raw data being collected. Currently there is no platform or consolidated system that integrates wide varieties of data, that applies machine learning technology to automate and increase the productivity of the integration and analysis of the data, and that generates profiles and action plans for operations management decisions action plans for improving throughput, return on investment, and output.

### SUMMARY OF THE INVENTION

The global aquiculture industry, which is the farming of aquatic plants and animals in off-shore waters, on-shore ponds, and indoor facilities, has grown dramatically since 2000 and now represents more than 50% of the seafood produced globally. Along with this growth in production, there has been an accelerating growth in the amount of research and operational data being produced by research organizations worldwide, by corporations serving the industry, and by aquaculture farm operators who are deploying larger and more automated systems. Despite this growth in data, there has been limited success in optimizing the use and value of the data for the industry and for researchers even though several published research indicates that the productivity and sustainability of an aquaculture farm operation can be improved significantly (10% to 60%) with changes in feed, fertilizer, or operational procedures. As a result, there is a growing need for a practical but innovative method for converting this data into useful knowledge.

To meet this need and solve this problem, a decision support system has been created by the inventors that uses machine learning algorithms to process large and sometimes sparse research and operating data sets to provide aquaculture farm operators and their control equipment with the best decisions about the diets and process control parameters for the specific species being farmed and for the specific aquaculture farm facility.

The growth of the aquaculture industry has been due in great part to the necessity of satisfying a growing demand for seafood per capita globally as well as the leveling off and decline of the production of wild capture seafood. The global ocean fisheries have been fished to near exhaustion. As a result, for economic and ecological reasons, the aquatic farming industry which has been in a state of small but consistent growth for decades has accelerated. While there has been acceleration in the growth of aquaculture farms globally, the pace of innovation in this industry has not moved forward as fast. As a result, much of the growth in aquatic farm facilities and the aquatic feed industry that supports them has happened without the major breakthroughs that analogously accompanied the green revolution in the global agriculture industry.

Research by Mote Marine Laboratory and other organizations (Ref. 1 to 86) has shown that the productivity of an aquatic farm can vary significantly as a function of the constituency of the feed and fertilizer, the process variables of the aquatic farm facilities, the handling of the aquatic species between growth phases, the species of plant and animals, and other environmental factors. Research projects around the world continue to show that improvements over the conventional feeds and process controls are possible and compelling. However, there is no clear way for the implications of these findings to be effectively deployed to the thousands of aquatic farm operators around the world.

The purpose of this invention is to provide facility-specific and species-specific information about how to control key feed and fertilizers parameters and aquatic farm environmental operating parameters in order to achieve maximum productivity for a specific aquatic farm facility. Conventional approaches to productivity improvement for the aquatic farming industry are based on the dissemination of general best practices in aquatic farming operations from aquatic farm industry suppliers, academic institutions, and government agencies. The present invention involves the application of machine learning technology to fine tune and optimize farming practices for a specific aquatic species, aquatic farm facility, and geography by combining general industry best practices with data collected from each specific aquatic farm operation.

Optimized aquatic farming operations includes the feeding process and the growing environment process.

Best feeding recipes in this case means ensuring that the constituency of the feed or fertilizer being given the aquatic species at each daily stage of their growth process will use the most ecologically sound, economically balanced, and organically productive combination of feed ingredients. Most ecologically sound means that there will be a minimum of fish meal used as ingredients and that alternative sources of nutrients from plant, insect, and other animal sources will be used. Most economically balanced means that the lowest cost combination of ingredients will be used to reduce the cost for the aquatic farm operators. Most organically productive means that the aquatic species will grow larger and faster than they would with other feed or fertilizer ingredient combinations.

Best operational care for the aquatic species being farmed means in this case that the parameters important for growth are known and optimized. Such parameters include the temperature, alkalinity, salinity, and contamination of the water, the density of the aquatic species, the transport conditions when the aquatic species are moved from one station to the next, and the physiological health of the aquatic species.

Aquatic farms are becoming more automated and have many electronic devices that control the environmental and farming process machinery. The decision recommendations from the present invention can be used directly as inputs to these industrial controls or indirectly to the human operators in charge of setting and monitoring the automation equipment.

Conventional techniques used by aquatic farm operators is to use information provided to them by the suppliers of feed or fertilizers, by the makers of the aquatic farm equipment, by researchers who publish their findings of improvements, and by the records kept by the aquatic farm operators of their own operations successes or failures. There is no effective or convenient method or tool for combining all these sources of information or to learn from successes or failures of different combinations of parameters.

The present invention is an innovation and improvement over existing methods because it uses machine learning computational techniques and algorithms to process all data sets available to each aquatic farmer from all commercial, public domain, and privately collected sources. The training of the learning algorithms is a combination of supervised and unsupervised learning methods depending on the source and quality of the raw data sets. The present invention will provide the individual aquatic farmer with a decision tool that grows in its intelligence by optimizing the usefulness of all data sets available to the aquatic farmer from external sources and by learning from internal data sets such as the proprietary data that is unique to a specific aquatic farm facility.

The net benefit of the use of the invention by aquatic farm operators is sustainable productivity. The aquatic farm using the invention will be more productive by producing more aquatic animal or plant product (by weight) using feed or fertilizer ingredients and aquatic farm machinery that cost the same or less than conventional ingredients and machinery. The aquatic farm will be more ecologically sustainable because (1) it will be using feed and fertilizer that consist of alternative less on fish meal based nutrients and more on alternative sources of natural nutrients, (2) it will be using aquatic farm machinery more efficiently, and (3) it will be creating a diminishing amount of waste and harmful byproducts from its operation.

### BRIEF DESCRIPTION OF THE DRAWINGS

FIG. 1 is block diagram of three generic types of aquaculture farms that grow aquatic species which includes land-based open air, land-based indoor, and ocean based in either coastal areas or in deep water areas.

FIG. 2 is a block diagram of an embodiment of typical operations in an aquatic species farm which includes a seeding or spawning step, a hatching or germination step, a seedling growth step, and then an adult grow-out step where the aquatic species reaches the desired full size.

FIG. 3 is a block diagram of an embodiment of an aquaculture decision optimization system using a learning engine.

FIG. 4 is a block diagram of an embodiment of data sources that are external to a specific aquatic farm operation.

FIG. 5 is a block diagram of an embodiment of data sources that are internal to a specific aquatic farm operation.

FIG. 6 is a block diagram of an embodiment of the constituents and process steps that are included in the feeding or fertilizing of aquatic species in an aquaculture farm operation.

FIG. 7 is a block diagram of an embodiment of the conditions and operational data that are included in a set of grow data.

FIG. 8 is a block diagram of an embodiment of a learning engine that is included in the aquaculture decision optimization system in the present invention.

FIG. 9 is a block diagram of an embodiment of a master knowledge base that is included in the aquaculture decision optimization system in the present invention.

FIG. 10 is a block diagram of an embodiment of a data cleaner that is included in the aquaculture decision optimization system in the present invention.

FIG. 11 is a block diagram of the learn process that is included in the learning engine of the aquaculture decision optimization system in the present invention.

FIG. 12 is a block diagram of the learning algorithms that are included the aquaculture decision optimization system in the present invention.

FIG. 13 is a block diagram of the rule generator that is included in the aquaculture decision optimization system in the present invention.

FIG. 14. is a block diagram of the plan generator that is included in the aquaculture decision optimization system in the present invention.

FIG. 15 is a block diagram of an embodiment of the user interface that is included in the aquaculture decision optimization system in the present invention.

### DETAILED DESCRIPTION OF THE INVENTION

One or more specific embodiments of the present disclosure are described below. When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters and/or conditions of the disclosed embodiments.

The embodiments described herein relate to a computer implemented method for optimizing decisions for operating an aquaculture system with the multiple goals of optimizing operations which includes maximizing the growth rate of, maximizing the quality of, and minimizing the cost of the aquatic species crop for a specific aquaculture farm. The computer implemented method consists of a digital learning engine which learns how to optimize operations from data supplied by suppliers and researchers and collected from prior operations. After learning how to optimize operations from the data, the digital learning engine generates decision rules and management action plans for use by the humans and machines that control the aquatic farming facility.

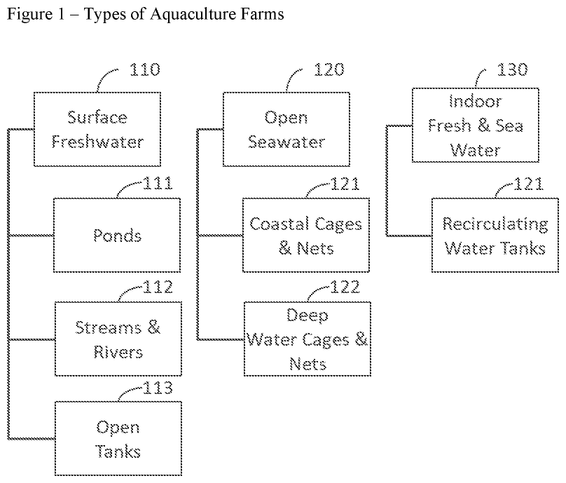

FIG. 1 is block diagram of three generic types of aquaculture farms which includes the farming of a wide variety of aquatic animals and plants. The first type of aquaculture farm is surface freshwater 110 facilities which include ponds 111, streams 112, and open tanks 113. A second type of aquaculture farm is open seawater 120 structures which include coastal cages or nets 121 structures that are near coastal areas and deep-water cages or nets 122 that are in deep seawater areas. A third area includes indoor fresh and seawater facilities 130 that reside on land which usually requires computer controlled recirculating water tanks 131.

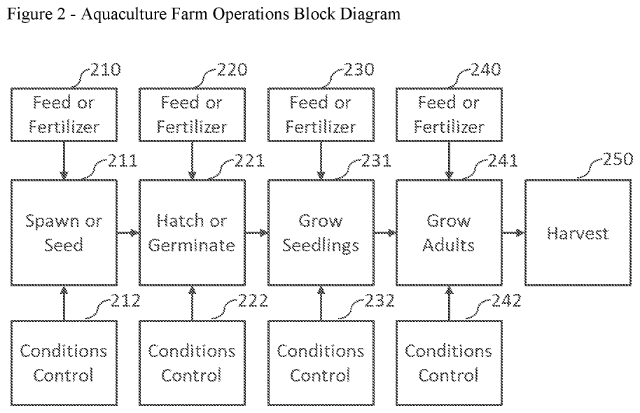

An embodiment of basic operational steps in a typical aquaculture farm is shown in FIG. 2. The spawn or seed 211 step is the production of eggs from a spawning operation for aquatic animals or a seeding operation for aquatic plants. This operation has some form of condition controls 212 for the conditions of the aquatic farm environment for this step. It also has some form of feed or fertilizer 210 to assist or stimulate the spawning or seeding process.

The hatch or germinate step 221 in FIG. 2 is the hatching of eggs or germination of seed. This operation has some form of condition controls 222 for the conditions of the aquatic farm environment for this step. It also has some form of feed or fertilizer 220 to assist or stimulate the hatch or germinate process growth process.

The grow seedling step 231 in FIG. 2 is the growing of seedling aquatic animals or plants. This operation has some form of conditions controls 232 for the conditions of the aquatic farm environment for this step. It also has some form of feed or fertilizer 230 to assist or stimulate the seedling growing process.

The grow adults step 241 in FIG. 2 is the final growing step wherein aquatic animals or aquatic plants are grown until they reach a harvestable adult maturity. This operation has some form of condition controls 242 for the conditions of the aquatic farm environment for this step. It also has some form of feed or fertilizer 240 to assist or stimulate the final growing process.

The final step 250 in FIG. 2 is the harvesting of the aquatic animals or aquatic plants.

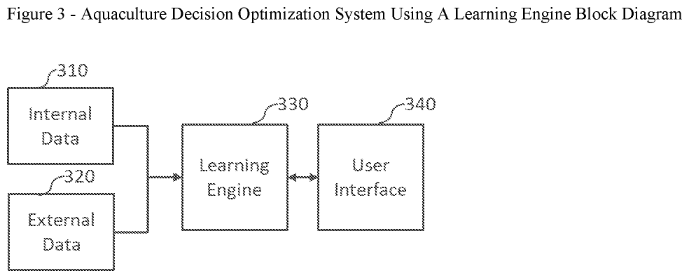

FIG. 3 is a block diagram of an embodiment of an aquaculture decision optimization system using a learning engine. The system comprises a learning engine 330 that receives inputs of internal data 310 that is generated or collected from sources internal the specific aquatic farm and of external data 320 that is provided by sources external to the specific aquatic farm.

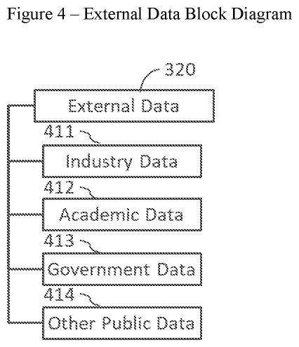

FIG. 4 is a block diagram of an embodiment of external data 320 that are provided by data sources that are external to a specific aquatic farm operation. The external sources include industry data 411 from organizations such as feed and fertilizer suppliers and aquaculture farm equipment suppliers, academic data 412 from organizations such as research universities, government data 413 from organizations such as federal, state, and local agencies, and other public data 414 from organizations such as non-profits and civic and professional associations.

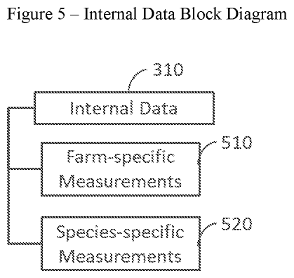

FIG. 5 is a block diagram of an embodiment of internal data 310 that are provided by data sources that are internal to a specific aquatic farm operation. The internal sources include farm-specific measurements 510 that are collected by humans or machines that operate within a specific aquaculture farm facility, and species-specific measurements that are collected by humans or machines that operate with a specific aquaculture facility. Globally there is a wide diversity in aquaculture facilities in terms of the degree of automation, age of equipment, skill level of human operators, and available resources as well as in terms of the aquatic species being grown. Such a wide range of differences amongst aquaculture facilities creates the opportunity for the present invention to provide an optimization of decision plans that are unique to each facility while at the same time taking advantage of optimization rules that can be learned from the industry at large. The external data 320 contributes to the optimization system learning from the industry at large. The internal data 310 contributes to the optimization system learning from the specific aquatic farm.

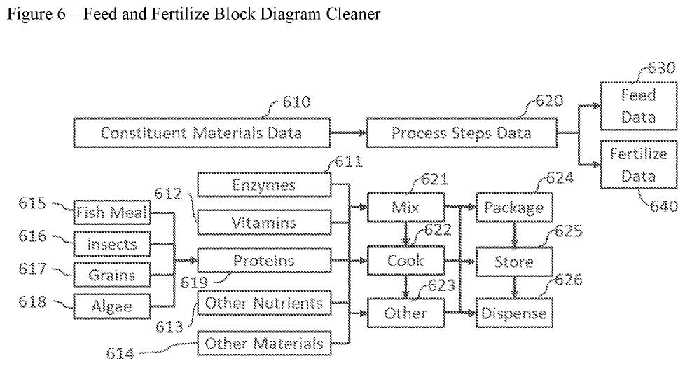

The block diagram in FIG. 6 is an embodiment of the constituents and process steps that are included in the feeding or fertilizing of aquatic species in an aquaculture farm operation. Constituent materials data 610 includes materials that comprise the recipes for the aquatic species feed data 630 or fertilizer data 640. The constituent materials include materials that are necessary for the aquatic species to grow such as enzymes 611, vitamins 612, proteins 619, and other nutrients 613, and other materials 614. There are alternative sources of proteins 619 that can offer growth, health, and cost benefits such as fish meal 615, insects 616, grains 617, and algae 618. Searching for the best average combination of feed constituents is an area of intense research by the feed and fertilizer industry. The present invention makes it possible for this type of search to be optimized for a specific aquaculture facility.

Process steps data 620 includes steps that comprise the preparation of the feed or fertilizer recipe. These steps include the actions of mix 621, cook 622, package 624, store 625, and dispense 626. There may be other 623 steps as well.

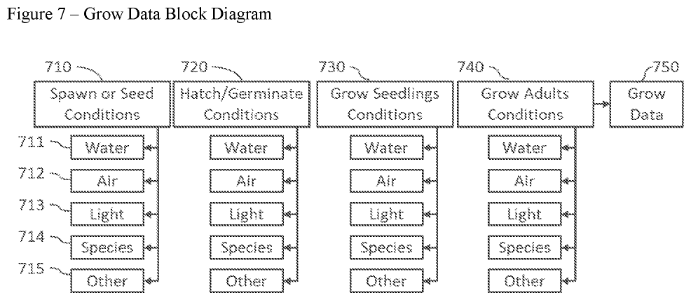

FIG. 7 is a block diagram of an embodiment of the conditions and operational data that are included in a set of grow data 750. Conditions data refers to the required values of the parameters that control or reflect the growing conditions within an operational step in an aquatic farm. For example, in spawn or seed conditions 710 the conditions that determine how effective the spawning or seed growing step is include water 711 conditions such as temperature, acidity, and salinity, air conditions 712 such as temperature and oxygenation levels, light 713 conditions such as lumens and color range, species 714 conditions such as genetic type, and other 715 conditions. There are similar sets of data for hatch/germinate conditions 720, grow seedlings conditions 730, and grow adults conditions 740.

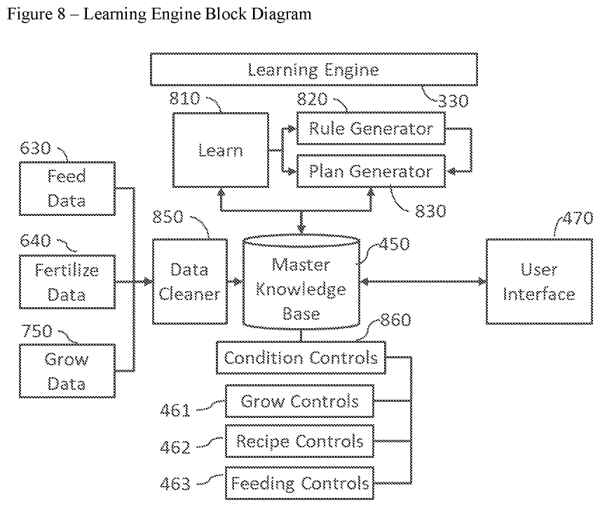

FIG. 8 is a block diagram of an embodiment of a learning engine that is included in the aquaculture decision optimization system in the present invention. The learning engine 330 comprises a data cleaner 850, conditions controls 860, a learn 810 process, a rule generator 820, and a plan generator 830. Central to the learning engine is the master knowledge base 450. Conditions control 860 includes data about the conditions within an aquatic facility that is species, facility, machine, process, rule, and plan specific. If a condition is not controllable by human or machine means, then that condition will not be included in the learning engine.

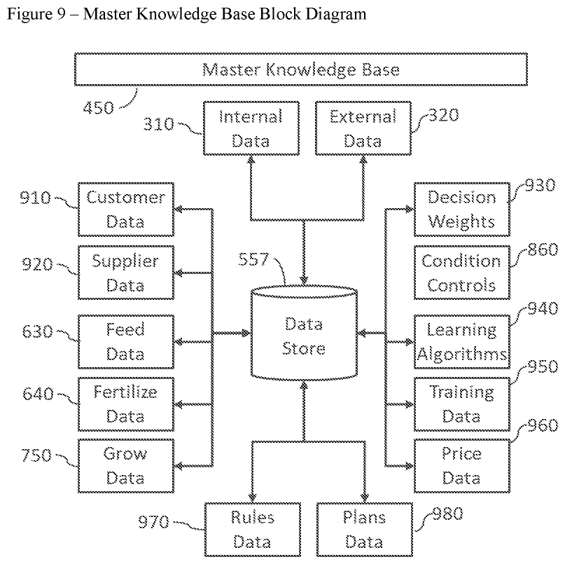

FIG. 9 is a block diagram of an embodiment of a master knowledge base 450 that is included in the aquaculture decision optimization system in the present invention. There is a variety of data digital housed in data store 990, which include customer data 910, supplier data 920, feed data 630, fertilize data 640, grow data 750, internal data 310, external data 320, decision weights 930, condition controls 860, learning algorithms 940, training data 950, price data 960, rules data 970, and plans data 980.

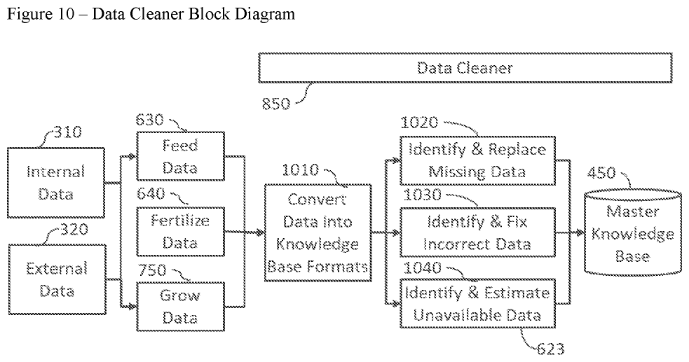

FIG. 10 is a block diagram of an embodiment of a data cleaner 850 that is included in the aquaculture decision optimization system in the present invention. The function of the data cleaner 850 is to convert data into master knowledge base formats 1010. The data being converted is coming from external data 320 and internal data 310 that includes feed data 630, fertilize data 640, and grow data 750. Cleaning data is necessary because the data from internal and external sources often have problems that need to be identified, corrected, or annotated before they can be used by the Learning Algorithms or added to the Master Knowledge Base. Data problems occur because data formats for instruments and machines are not uniform, measurements made by machines as well as humans are contaminated in part with random noise, measurement data rates have different frequencies, amplitudes of measured values may not be absolute, and a variety of other problems. The data conversion process includes identify and replace missing data 1020, identify and fix incorrect data 1030, and identify & estimate missing data 1040.

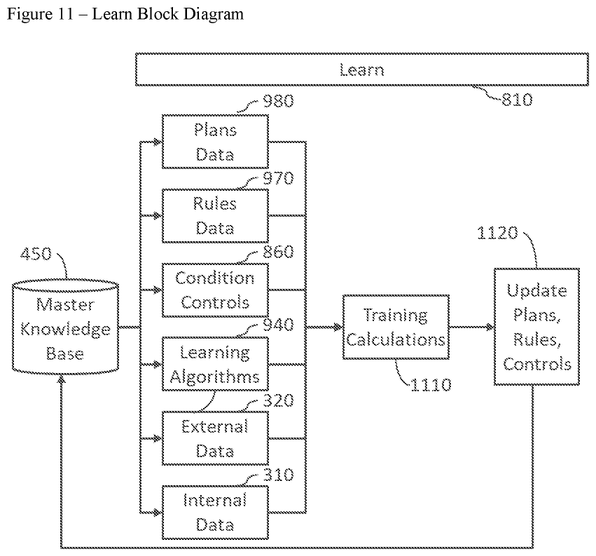

FIG. 11 is a block diagram of the learn 810 process that is included in the learning engine of the aquaculture decision optimization system in the present invention. The purpose of the learn 810 is to apply a library of machine learning algorithms 940 to external data 320 or internal data 310 or both. Training calculations 1120 is the execution of a selected machine algorithm on selected data learn from the new data and train rules 970 that are related to the new data. The output of training calculations 1110 causes the update of plans, rules, and controls 1120. Each plan in plan data 980 is a set of rules from rules data 970 which define a profile or set of controls to be performed by human or machine in condition controls 860.

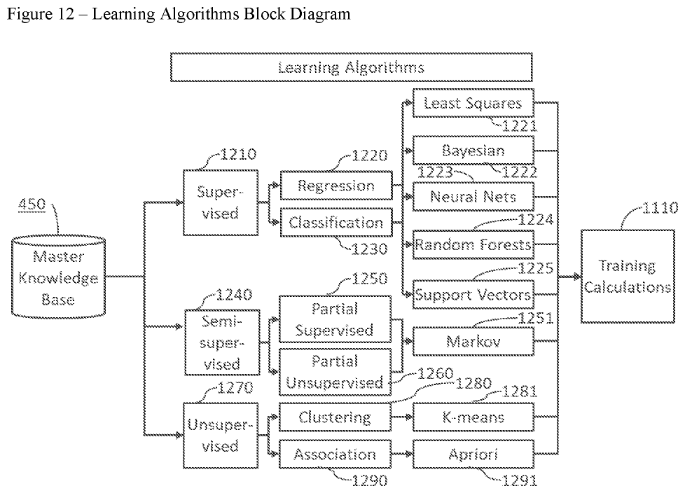

FIG. 12 is a block diagram of an embodiment of the learning algorithms that are included the aquaculture decision optimization system in the present invention. The Supervised 1210 digital library of algorithms includes Regression 1220 algorithms and Classification 1230 algorithms. Supervised machine learning generally refers to the use of human experts to define the types of models or labels to be trained by data sets. In essence, a machine learning algorithm is supervised by decisions made by a human expert as it calculates the best matches based on the data the algorithm is presented.

The algorithms in the Regression 1220 digital library can be chosen from a variety of sources. Regression 1220 algorithms are designed to calculate coefficients for a polynomial that produces a best fit between the polynomial equation and many sets of data. This best fit polynomial then becomes the new or updated model for a Plan which is a set of Rules for how to grow a specific species in a specific facility. The calculations and simulations used to determine the best fit model is the training process for the new or updated Plan or set of Rules.

The algorithms in the Classification 1230 digital library can be chosen from a variety of sources. Classification 1230 algorithms are designed to split data into categories which have labels that have been discovered or predefined by human experts. There are a variety of classification algorithms which use different types of equations to determine best fit within a classification.

The mathematical approaches that can be used in Supervised 1210 algorithms for both Regression 1220 and Classification 1230 applications include Least Squares 1221, Bayesian 1222, Neural Nets 1223, Random Forests 1224, and Support Vectors 1225. Least Squares 1221 algorithms compute the coefficients for a polynomial that makes the distance between data points and the polynomial as small as possible. In Least Squares 1221 algorithms, there are no assumptions about what causes the differences between the data sets and the polynomial models. In Bayesian 1222 algorithms, assumptions are included that the causes of the differences between the data sets and the polynomial models are statistical in nature. The typical assumptions in Bayesian 1222 models include that the distribution is normal and that the mean and variance are known. In Neural Nets 1223 algorithms, regression or classification polynomial calculations are organized as a parallel processing problem by assigning and modifying the weights or coefficients of the polynomial terms they flow through one or more hidden layers of parallel states. In Random Forest 1224 algorithms, data sets are randomly selected, used to create several different decision trees often by different human experts, and then statistically merged or averaged together to produce a set of coefficients for matching polynomials or categories. In Support Vectors 1225 machines, the approach to classifying sets of data is to calculate a polynomial model surface that separates the categories of data best rather than calculating a polynomial surface that fits the data within a category best. The coefficients of the polynomial that describes the separating plane can be represented as a vector in matrix algebra.

The Unsupervised 1270 digital library of algorithms includes Clustering 1280 algorithms and Association 1290 algorithms. Unsupervised 1270 algorithms are called unsupervised because an assumption is made that there is no set of labels or categories predefined by human experts that can be used to supervise, guide, or set the starting point for the machine learning calculations. Unsupervised machine learning algorithms are sometimes called data mining algorithms because the algorithms are mining or searching for some type classification or labels from raw data.

Clustering 1280 machine learning algorithms include the use of mathematical techniques for grouping a set of data in such a way that data in the same group (called a cluster) are more similar (in some calculable sense) to each other than to data in other groups (clusters). Because the clustering approach is unsupervised, it usually requires several iterations of analysis until consistently clear categorizations and groupings can be identified from the data sets being analyzed.

The Clustering 1280 digital library includes the K-means 867 algorithm. The K-means 1281 calculates the average distance between the centroid of K clusters in a dataset. At the start of the analysis, a number is chosen for K. Every data point is allocated to each of the K clusters through reducing the in-cluster sum of squares difference from each of the centroids. This process is iterative and takes several steps to correct each centroid location and minimize the sum of squares of the distances from the data points in each cluster to the centroid. Then a lower value of K and a higher value of K can be chosen to see if either of those numbers of clusters produces a lower mean or tighter fit. The iterations end when a value of K is found which produces the lowest sum of squares difference.

Association 1290 machine learning algorithms include the use of correlation calculations to identify important relationships between categories or clusters of items in a data set. Relationships discovered by association machine learning algorithms can be used to generate new labels or categories for additional machine learning algorithm calculations.

Apriori 1291 is a digital library of algorithms that search for a series of frequent sets of relationship in datasets. For example, assume that a data set has five categories identified such as A, B, C, D, and E and that an association algorithm has identified a relationship between category A and B (e.g. if a data set has data in category A, 50% of the time it has data in a category B). An Apriori algorithm might find that if a data set has data in categories A and B, it has data in Category C 80% of the time.

Because it is not always possible to have data sets that can be analyzed with Supervised 1210 algorithms and because it is sometimes expensive and difficult to use only Unsupervised 1270 algorithms, an approach which speeds up the analysis process is to use a Semi-supervised 1240 approach to using machine learning algorithms. The Semi-supervised 1240 learning approach combines a small amount of data that can be used in a Supervised 1210 approach to a large amount of data that can be used in an Unsupervised 1270 approach. Markov 12151 algorithms, which are based on assumptions about the statistical randomness of the data being analyzed, can then be applied to complete the training calculations of the Semi-supervised approach.

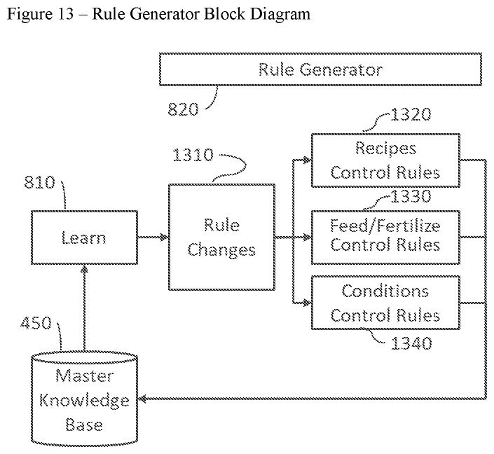

FIG. 13 is a block diagram of the rule generator 820 that is included in the aquaculture decision optimization system in the present invention. The rule generator 820 includes software tools that the output from learn 810 and make rule changes 1310 that are either new or updated rules for facility-specific and species-specific recipe control rules 1320, feed/fertilize control rules 1330, and conditions control rules 1340. Each time new data from the master knowledge base 450 is analyzed by learn 810, new or updated rules are added to master knowledge base 450.

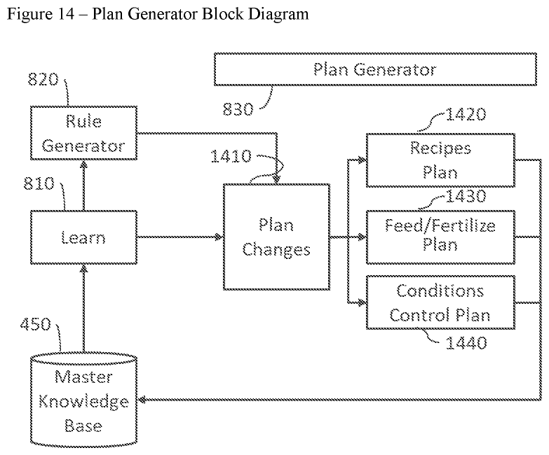

FIG. 14. is a block diagram of the plan generator 830 that is included in the aquaculture decision optimization system in the present invention. A plan is a set of rules about how each batch or crop of a species-specific aquatic animal or plant species should be grown, feed, and fertilized during a full growing cycle within a facility-specific operation. A plan is specific to a facility, a species being, a batch, and a set of performance objectives.

The plan generator 830 includes software tools that makes plan changes 1410 that are either new or updated plans based on new or updated rules from rule generator 820 for facility-specific and species-specific recipe plans 1420, feed/fertilize plans 1430, and conditions control plans 1440. recipe control rules 1320, feed/fertilize control rules 1330, and conditions control rules 1340. Each time new data from the master knowledge base 450 is analyzed by learn 810, new or updated plans are added to master knowledge base 450.

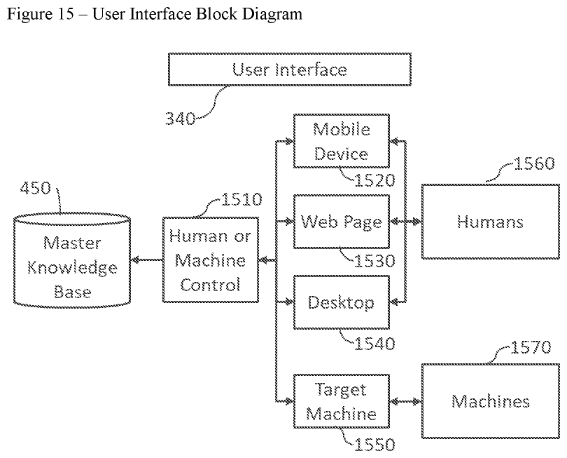

FIG. 15 is a block diagram of an embodiment of the user interface 340 that is included in the aquaculture decision optimization system in the present invention. User interface 340 includes software tools that support decide whether data from the master knowledge base 450 is required for human or machine control 1510. If the data is required by humans 1560, then software tools prepare the data for delivery through a mobile device 1520, a web page 1530, or a desktop 1540 device. If the data is required by machines 1570, then software tools prepare the data for delivery through the technical requirements of the target machine 1550.

The invention claimed is:

1. A computer implemented method of controlling an aquaculture system, comprising:
A library of sets of data that describe a specific aquatic species being grown, the food and fertilizer being feed to a specific aquatic species, and the measurable and controllable environmental conditions of an aquatic farm operation;
A library of machine learning algorithms that can be applied to sets of data for the purpose of training profiles of decisions to be used during the operation of the aquatic species farm during a specific growing cycle;
A library of decision profiles wherein each profile includes a list of decision rules, decision steps, and controllable parameter values that maximize the growth rate, maximize the quality, and minimize the cost of specific lots of specific aquatic species, and specific facilities;
A learning engine wherein a machine learning algorithm is selected from the library of machine learning algorithms and then used to train a decision profile by calculating the best fit of data from data sets stored in the library of sets of data to the algorithm mathematical equations; and
A user interface that provides decision data electronically to a human operator or to a computer-controlled machine wherein the controllable conditions within an aquatic animal or plant species are adjusted to achieve the objective of optimizing the aquatic farm operation.

2. The method of claim 1, wherein the aquatic species comprises freshwater animals.

3. The method of claim 1, wherein the aquatic species comprises saltwater.

4. The method of claim 1, wherein the aquatic species comprises freshwater plants.

5. The method of claim 1, wherein the aquatic species comprise saltwater plants.

6. The method of claim 1, wherein the aquatic farm operation includes operations contained indoors within a constructed facility.

7. The method of claim 1, wherein the aquatic farm operation includes operations contained outdoors on land with aquatic species growing in ponds, raceways, or tanks open to the air.

8. The method of claim 1, wherein the aquatic farm operation includes operations contained at sea near coastal areas or in deep water with aquatic species growing in cages of various types and geometries.

9. The method of claim 1, wherein the library of sets of data includes data that is measured and collected from equipment and instruments within a specific aquatic farm operation.

10. The method of claim 1, wherein the library of sets of data includes data that is provided by organizations external to a specific aquatic farm operation.

11. The method of claim 1, wherein the user interface provides decision data electronically to a mobile electronic device through an electronic network.

12. The method of claim 1, wherein the user interface provides decision data electronically to a stationary or desk top electronic device through an electronic network.
